(19) United States
(12) Patent Application Publication
(10) Pub. No.: US 2010/0033891 A1
(43) Pub. Date: Feb. 11, 2010

(54) IONIZER HAVING MECHANISM FOR CLEANING DISCHARGE ELECTRODES

(75) Inventors: Masayuki ORIHARA, Tsukubamirai-shi (JP); Takayuki Toshida, Tsukubamirai-shi (JP); Akira Tadano, Tsukubamirai-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: SMC Corporation, Chiyoda-ku (JP)

(21) Appl. No.: 12/503,195

(22) Filed: Jul. 15, 2009

(30) Foreign Application Priority Data
Aug. 7, 2008 (JP) 2008-204689

(51) Int. Cl. H01T 23/00

(52) U.S. Cl. 361/231

(57) ABSTRACT

Discharge electrodes for generating ion and a member for cleaning the discharge electrodes are mounted on an electrode support frame, which is detachably attached to the case of an ionizer. When the electrode support frame is attached to the case, the cleaning member occupies a retraction position where the cleaning member does not shut off or disturb air that is supplied from a fan. Upon the detachment of the electrode support frame from the case, the cleaning member becomes moveable. Then, the cleaning member is moved while being brought into contact with the discharging parts of the discharge electrodes one after another. As a result, the cleaning member sweeps dust or other particles off the discharging parts thereof.

### BACKGROUND OF THE INVENTION

[1] Field of the Invention

The present invention generally relates to an ionizer that is used for diselectrifying a workpiece that is electrified with a positive electric charge or a negative electric charge, that is, an ionizer that is used for the electrical neutralization thereof. In particular, the invention relates to an ionizer having a mechanism for cleaning discharge electrodes that generate positive ions and negative ions by means of corona discharge. An ionizer to which the invention is directed makes it possible for a user to clean such discharge electrodes with the use of a pair of cleaning members, or at least one cleaning member, when they are not clean.

[2] Description of the Related Art

An ionizer that utilizes corona discharge is used in the work-processing steps of various kinds of workpieces such as a semiconductor wafer, a liquid crystal glass, and the like in order to electrically neutralize a workpiece that is charged positively and negatively with static electricity (i.e., destaticization). Ionizers utilizing corona discharge can be roughly classified into direct current (DC) ionizers and alternating current (AC) ionizers. For example, a DC ionizer has positive discharge electrodes and negative discharge electrodes that have a needle-like tip shape. Through the application of a positive high voltage to the positive discharge electrodes and the application of a negative high voltage to the negative discharge electrodes, corona discharge is generated at the discharging part of each of the discharge electrodes, which is the front-end part thereof. Positive ions and negative ions are generated due to the corona discharge. The generated positive and negative ions are blown on a workpiece, which is the target of diselectrification, with the use of a flow of destaticizing air. By this means, the DC ionizer neutralizes a positive electric charge and a negative electric charge on the target workpiece. On the other hand, an AC ionizer applies an alternating voltage to discharge electrodes so that positive ions and negative ions are generated alternately from the discharge electrodes.

In such a typical ionizer of related art, when corona discharge is generated at discharge electrodes, dust particles suspended in the air are attracted to the discharging parts of the discharge electrodes. As dust settles thereon and adheres thereto, the discharging parts of the discharge electrodes become insulated gradually. The gradual insulation of the discharging parts of the discharge electrodes makes it harder to generate corona discharge, which obstructs ion generation. If the generation of ion is obstructed, the diselectrification efficiency of the ionizer decreases. In order to avoid the deterioration of the destaticization performance of the ionizer, it is necessary to clean the discharging parts of discharge electrodes thereof periodically with the use of a cleaning member such as a brush or the like. If a separate cleaning member that does not constitute a part of the ionizer is provided/used for cleaning, a user might forget to keep the cleaning member for the next use, or the cleaning member may be lost.

In order to overcome such a problem, an ionizer that is provided with a cleaning member (brush member) in addition to discharge electrodes and a fan inside the air-blow hole of a case has been proposed in the art as described in Japanese Unexamined Patent Application Publication No. 2004-234972. The ionizer described in Japanese Unexamined Patent Application Publication No. 2004-234972 is provided with a movable member that turns when driven by the flow of air that is supplied from the fan inside the air-blow hole. The cleaning member is mounted on the movable member. When the cleaning member turns together with the movable member, it is brought into contact with the front-end parts of the discharge electrodes one after another. As a result, the cleaning member sweeps dust particles off the front-end parts thereof.

However, the ionizer described in Japanese Unexamined Patent Application Publication No. 2004-234972 has the following disadvantages. Since the movable member and the cleaning member are provided inside the air-blow hole, the movable member and the cleaning member shut off or disturb the flow of air containing ions, which results in a decrease in air-blowing efficiency. In addition, ion recombination occurs due to the mixture of positive ions and negative ions, which is caused by the disturbance of air. If ion recombination occurs, the amount of ion that reaches a diselectrification target workpiece decreases.

Moreover, the ionizer described in the publication identified above has the following disadvantages. Since the cleaning of the discharge electrodes is conducted during the operation of the ionizer, dust particles that have been swept off the discharging parts of the discharge electrodes are scattered by the flow of air. The scattered dust particles could re-adhere to other part of the ionizer. Or, the scattered dust particles could flow out of the ionizer and contaminate a diselectrification environment. Or, the scattered dust particles could be blown to a diselectrification target workpiece and make it unclean.

### BRIEF SUMMARY OF INVENTION

An advantage of some aspects of the invention is to provide an ionizer having a member(s) for cleaning discharge electrodes that makes it possible to conduct cleaning without causing the shutoff or disturbance of air that is supplied from a fan because of the presence of the cleaning member. Another advantage of some aspects of the invention is to provide an ionizer having a member(s) for cleaning discharge electrodes that makes it possible to prevent dust or other particles that have been swept off the discharging parts of the discharge electrodes from being scattered by the flow of air, which could otherwise cause the contamination of a diselectrification environment or a diselectrification target workpiece.

In order to overcome the disadvantages explained above without any limitation thereto, the invention provides, as an aspect thereof, an ionizer having a discharge-electrode cleaning mechanism, the ionizer including: a case; an air hole that is formed in the case; a fan that supplies air, the fan being provided inside the air hole; a plurality of discharge electrodes that generates positive ions and negative ions by corona discharge, the plurality of discharge electrodes being provided at positions exposed to and/or facing the air hole in the case; an electrode support flame that is detachably attached to the case with the plurality of discharge electrodes being mounted on the electrode support frame; and a cleaner that is used for cleaning the plurality of discharge electrodes, the cleaner being movably attached to the electrode support frame in such a manner that the cleaner can move from one discharge electrode to another as well as between one discharge electrode and another while being brought into contact with the plurality of discharge electrodes one after another, wherein the cleaner occupies a retraction position that is distanced from the area of the air hole when the electrode support frame is attached to the case; and the cleaner becomes moveable for the purpose of cleaning the plurality of discharge electrodes when the electrode support frame is detached from the case.

In the configuration of an ionizer according to an aspect of the invention described above, it is preferable that the electrode support frame should be made up of a first electrode support frame that is detachably attached at a position corresponding to one half of the air hole and a second electrode support frame that is detachably attached at a position corresponding to the other half of the air hole; and the plurality of discharge electrodes and the cleaner should be provided on each of the first electrode support frame and the second electrode support frame.

In the preferred configuration of an ionizer described above, it is further preferable that each of the first electrode support frame and the second electrode support frame should include a curved part that has the shape of an arc that coincides with a part of the air hole that has the shape of a circle, and should further include a guide that is formed adjacent to the curved part in each of the front face and the rear face of each of the electrode support frames, wherein each discharge electrode is mounted on the curved part of each of the electrode support frames in such a position and orientation that a discharging part of each discharge electrode protrudes in the air hole; wherein the cleaner, which is configured to move freely along the guide of each of the electrode support frames, includes a brush holder that is attached at the curved part of each of the electrode support flames in such a manner that the brush holder sandwiches a part of each of the electrode support frames; a brush that is provided inside the brush holder in such a manner that the brush can be brought into contact with the discharge electrode; and a slider that can slide freely along the guide.

In the preferred configuration of an ionizer described above, it is further preferable that the guide which is formed as a groove, should include a main part that is gently curved along the curved part; and should further include a recess part that extends from one end of the main part in such a manner that the guide is bent at the one end of the main part; wherein the slider is made up of a plurality of sliding projections that fits in the guide so as to be able to slide freely along the guide, the plurality of sliding projections being formed on the inner surface of side plate parts of the brush holder; and when the cleaner is moved to the end of the guide in such a manner that some of the sliding projections is/are fitted in the recess part, the cleaner occupies the retraction position.

In the preferred configuration of an ionizer described above, it is further preferable that the first electrode support frame and the second electrode support frame should have interchangeability so that the electrode support frame can be attached to the case even when the first electrode support frame and the second electrode support frame are replaced with each other.

As a preferred configuration of an ionizer according to an aspect of the invention described above, the case may be provided with a plurality of feeding terminals that is electrically connected to a high voltage source; the electrode support frame may be provided with a plurality of receiving terminals that is electrically connected to the discharge electrodes; and the receiving terminals may become connected to the feeding terminals respectively upon the attachment of the electrode support frame to the case.

As a preferred configuration thereof, an ionizer according to an aspect of the invention described above may include a plurality of pairs of discharge electrodes each of which is made up of a pair of discharge electrodes that generate ion having polarities opposite to each other, wherein a distance from the tip of one of the two discharge electrodes in each pair of discharge electrodes to the center of the air hole is different from a distance from the tip of the other of the two discharge electrodes in each pair of discharge electrodes to the center of the air hole.

In the configuration of an ionizer according to an aspect of the invention described above, the discharge electrodes and the cleaner are provided on the electrode support frame that is detachably attached to the case. The cleaning of the discharge electrodes is conducted with the use of the cleaner after the stopping of the operation of the ionizer and the detaching of the electrode support frame from the case. Therefore, unlike an ionizer of related art, an ionizer according to an aspect of the invention described above makes it possible to prevent dust or other particles that have been swept off the discharging parts of the discharge electrodes from being scattered by the flow of air supplied from the fan, which could otherwise cause the contamination of a diselectrification environment or a diselectrification target workpiece. In addition, since the cleaner occupies (e.g., is set at) a retraction position that is distanced from the area of the air hole when the electrode support frame is attached to the case, unlike an ionizer of related art, an ionizer according to an aspect of the invention described above makes it possible to prevent the cleaner from shutting off or disturbing air that is supplied by and flows from the fan during the operation thereof.

### BRIEF DESCRIPTION OF DRAWINGS

FIG. 1 is a perspective view that schematically illustrates an example of the general appearance of an ionizer according to an embodiment of the invention.

FIG. 2 is a sectional view that schematically illustrates an example of the configuration of the essential parts of the ionizer illustrated in FIG. 1.

FIG. 3 is a front view that schematically illustrates an example of the inner configuration of the essential parts of a fan unit according to an embodiment of the invention.

FIG. 4 is a perspective view that schematically illustrates an example of the frame-detached appearance of the ionizer illustrated in FIG. 1, where a pair of discharge electrode support frames is taken out of the ionizer.

FIG. 5 is a sectional view that schematically illustrates an example of the configuration of the essential parts of a discharge electrode according to an embodiment of the invention.

FIG. 6 is a front view that schematically illustrates an example of the configuration of one of the pair of discharge electrode support frames according to an embodiment of the invention.

FIG. 7 is a rear view that schematically illustrates an example of the configuration of the discharge electrode support frame illustrated in FIG. 6.

FIG. 8 is a front view that schematically illustrates an example of the cleaning of the discharge electrodes with the use of the cleaning member according to an embodiment of the invention.

FIG. 9 is an enlarged view that schematically illustrates an example of the configuration of essential parts illustrated in FIG. 8.

FIG. 10 is a perspective view that schematically illustrates an example of the configuration of the cleaning member according to an embodiment of the invention.

FIG. 11 is a partial sectional view that schematically illustrates another example of the configuration of the cleaning member according to an embodiment of the invention.

### DETAILED DESCRIPTION OF INVENTION

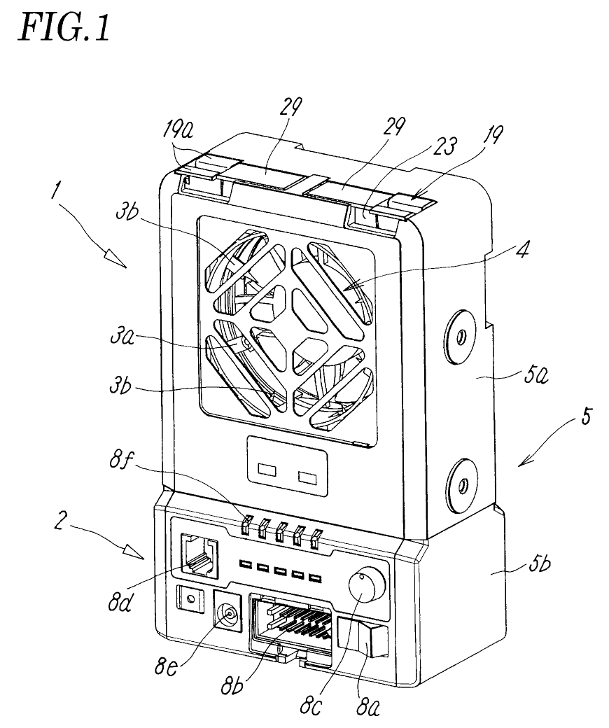

FIGS. 1-4 schematically illustrate an example of the configuration of an ionizer having a mechanism for cleaning discharge electrodes according to an exemplary embodiment of the invention. The ionizer illustrated therein is a direct current (DC) device. Corona discharge is generated when a high-voltage generating device 12a and another high-voltage generating device 12b apply a positive DC high voltage and a negative DC high voltage to positive discharge electrodes 3a and negative discharge electrodes 3b, respectively. Positive ions and negative ions are generated due to the corona discharge. An ionizer according to the present embodiment of the invention blows the generated positive and negative ions on a workpiece, which is the target of diselectrification, by generating a flow of destaticizing air with the use of a fan 4. An ionizer according to the present embodiment of the invention is provided with a fan unit 1 that includes the discharge electrodes 3a and 3b in addition to the fan 4 and is further provided with a control unit 2 that has a built-in controller 7. The built-in controller 7 controls the operation of the high-voltage source devices 12a and 12 as well as the operation of the fan 4. The fan unit 1 is provided as the upper unit of the ionizer, which is installed on the lower unit thereof, that is, the control unit 2.

The fan unit 1 includes an upper case 5a. The upper case 5a has the shape of a rectangular parallelepiped. The upper case 5a is made of a synthetic resin. A circular air-blow hole 10 is formed in the upper case 5a. The air-blow hole 10 is opened both in the frontward direction through the front body of the fan unit 1 and in the rearward direction through the rear body thereof. A plurality of positive discharge electrodes 3a and a plurality of negative discharge electrodes 3b are mounted on a discharge electrode support frame 11a. In addition, a plurality of positive discharge electrodes 3a and a plurality of negative discharge electrodes 3b are mounted on another discharge electrode support frame 11b. The plurality of positive discharge electrodes 3a and the plurality of negative discharge electrodes 3b are provided at the inner-circumference part of the air-blow hole 10. The tip of each of the positive/negative discharge electrodes 3a and 3b is oriented toward the center O of the circular air-blow hole 10. Centering on the position O, the plurality of positive discharge electrodes 3a and the plurality of negative discharge electrodes 3b are arrayed at predetermined regular circumferential intervals. The fan 4 is provided inside the air-blow hole 10 mentioned above. The fan 4 generates a flow of air. Positive ions generated by the positive discharge electrodes 3a and negative ions generated by the negative discharge electrodes 3b are blown on a charged workpiece for the diselectrification thereof because of the airflow supplied by the fan 4.

The control unit 2 includes a lower case 5b, which is made of a synthetic resin. The built-in controller 7 is encased in the resin-made lower chassis 5b. A power switch 8a, a wiring connector 8b, a rotary switch 8c, a modular connector 8d, an alternating current (AC) adapter connection jack 8e, a status indicator 8f, and the like, are provided on the front face of the lower case 5b. The wiring connector 8b is used for line connection between the control unit 2 and an external power supply device or other external device. The rotary switch 8c is used for controlling air volume. The modular connector 8d is used for modular connection between the control unit 2 and an external sensor. The status indicator 8f indicates the operating state of the ionizer.

In addition to its main function as a controlling device, the control unit 2 functions also as an installation base (i.e., pedestal) when the ionizer is placed at a certain installation site. The dimension of the control unit 2 when viewed in the depth direction is greater than that of the fan unit 1 in the illustrated configuration of an ionizer according to the present embodiment of the invention. Notwithstanding the above, however, the depth of the control unit 2 may be the same as that of the fan unit 1.

Each of the upper case 5a of the fan unit 1 and the lower case 5b of the control unit 2 constitutes a part of the entire chassis of an ionizer according to the present embodiment of the invention. Therefore, in the following description of this specification, the upper case 5a of the fan unit 1 and the lower case 5b of the control unit 2 may be collectively referred to as a “case 5”. The upper case 5a and the lower case 5b may be formed as a single case unit such as a single molded unit or the like. Or, the upper case 5a and the lower case 5b may be formed as two case units separated from each other, which are combined into one case unit thereafter in a detachable manner.

The fan 4 is made up of an electric motor 4a, which is provided at the center thereof, and blades 4b, which are fixed to the power output shaft of the electric motor 4a. The fin 4 is provided inside the air-blow hole 10 concentrically. The electric motor 4a of the fan 4 is electrically connected to the built-in controller 7 mentioned above.

The positive high-voltage generating device 12a and the negative high-voltage generating device 12b are provided inside the fan unit 1. The positive high-voltage generating device 12a applies a positive high voltage to the positive discharge electrodes 3a mentioned above. The negative high-voltage generating device 12b applies a negative high voltage to the negative discharge electrodes 3b mentioned above. The positive high-voltage generating device 12a and the negative high-voltage generating device 12b are electrically connected to the built-in controller 7. In addition, the positive high-voltage generating device 12a and the negative high-voltage generating device 12b are electrically connected to the positive discharge electrodes 3a and the negative discharge electrodes 3b, respectively.

Generally speaking, a DC non-pulse ionizer that applies a high voltage continuously at a fixed level and a DC pulse ionizer that applies a pulsed high voltage are known in the art. Either type can be adopted in the present embodiment of the invention.

As a modification example of the configuration explained above, the positive high-voltage generating device 12a and the negative high-voltage generating device 12b may be provided not inside the fan unit 1 but inside the control unit 2 together with the built-in controller 7. Or, as another modification example thereof, the built-in controller 7 may be provided not inside the control unit 2 but inside the fan unit 1 together with the positive high-voltage generating device 12a and the negative high-voltage generating device 12b.

One positive discharge electrode 3a and one negative discharge electrode 3b make a pair of discharge electrodes, which is denoted as 3A or 3B. In the illustrated example of the configuration of an ionizer according to the present embodiment of the invention, four positive discharge electrodes 3a and four negative discharge electrodes 3b are arrayed alternately. Four pairs of discharge electrodes, or more specifically, two pairs of discharge electrodes 3A and two pairs of discharge electrodes 3B, are provided where each pair of discharge electrodes is made up of one positive discharge electrode 3a and one negative discharge electrode 3b. These two pairs of discharge electrodes 3A and two pairs of discharge electrodes 3B are arrayed at a predetermined regular distance substantially along the inner circumference of the air-blow hole 10 around the center O thereof.

Each of the positive discharge electrode 3a and the negative discharge electrode 3b that make up each pair of discharge electrodes 3A, 3B protrudes inside the air-blow hole 10. It should be noted that the length of the protrusion of the positive discharge electrode 3a is different from the length of the protrusion of the negative discharge electrode 3b in each pair of discharge electrodes 3A, 3B. That is, the electrode length of the positive discharge electrode 3a is not the same as the electrode length of the negative discharge electrode 3b in each pair of discharge electrodes 3A, 3B. In other words, the distance between the tip of the positive discharge electrode 3a and the center O of the air-blow hole 10 is not the same as the distance between the tip of the negative discharge electrode 3b and the center O of the air-blow hole 10 in each pair of discharge electrodes 3A, 3B. In the following description of this specification, the distance between the tip of the positive/negative discharge electrode 3a, 3b and the center O of the air-blow hole 10 may be referred to as a “from-tip-to-center distance” or “between-tip-and-center distance”. In such a structure, the relationship between “the distance between the tip of the positive discharge electrode 3a and the center O of the air-blow hole 10” and “the distance between the tip of the negative discharge electrode 3b and the center O of the air-blow hole 10” in each pair of discharge electrodes 3A, that is, the distance between the tip of the positive discharge electrode 3a and the center O of the air-blow hole 10 relative to the distance between the tip of the negative discharge electrode 3b and the center O of the air-blow hole 10 or vice versa in each pair of discharge electrodes 3A, is different from the relationship between “the distance between the tip of the positive discharge electrode 3a and the center O of the air-blow hole 10” and “the distance between the tip of the negative discharge electrode 3b and the center O of the air-blow hole 10” in each pair of discharge electrodes 3B, that is, the distance between the tip of the positive discharge electrode 3a and the center O of the air-blow hole 10 relative to the distance between the tip of the negative discharge electrode 3b and the center O of the air-blow hole 10 or vice versa in each pair of discharge electrodes 3B. Specifically, the first-type pair of discharge electrodes 3A (i.e., each of two first pairs of discharge electrodes 3A) is made up of one positive discharge electrode 3a that has a relatively short electrode length so as to have a relatively long from-tip-to-center distance defined above and one negative discharge electrode 3b that has a relatively long electrode length so as to have a relatively short from-tip-to-center distance defined above, whereas the second-type pair of discharge electrodes 3B (i.e., each of two second pairs of discharge electrodes 3B) is made up of one positive discharge electrode 3a that has a relatively long electrode length so as to have a relatively short from-tip-to-center distance defined above and one negative discharge electrode 3b that has a relatively short electrode length so as to have a relatively long from-tip-to-center distance defined above.

These two first-type pairs of discharge electrodes 3A and two second-type pairs of discharge electrodes 3B are arrayed alternately so as to encircle the center O of the air-blow hole 10 in such a manner that the two first-type pairs of discharge electrodes 3A Ire provided in an opposite array layout with respect to the center O of the air-blow hole 10 and further that the two second-type pairs of discharge electrodes 3B are also provided in an opposite array layout with respect to the center O of the air-blow hole 10. That is, the two first-type pairs of discharge electrodes 3A are provided opposite to each other with respect to the center O of the air-blow hole 10. In addition, the two second-type pairs of discharge electrodes 3B are provided opposite to each other with respect to the center O of the air-blow hole 10. In such an opposite array layout, an array angle that is formed by each two “adjacent” positive discharge electrodes 3a one of which belongs to one of the four pairs of discharge electrodes 3A, 3B (e.g., 3A) and the other of which belongs to another one of the four pairs of discharge electrodes 3A, 3B (e.g., 3B) that is adjacent to the above-mentioned one of the four pairs of discharge electrodes 3A, 3B and not opposite to the above-mentioned one of the four pairs of discharge electrodes 3A, 3B is approximately 90°. In addition, in such an opposite array layout, an array angle that is formed by each two “adjacent” negative discharge electrodes 3b one of which belongs to one of the four pairs of discharge electrodes 3A, 3B (e.g., 3A) and the other of which belongs to another one of the four pairs of discharge electrodes 3A, 3B (e.g., 3B) that is adjacent to the above-mentioned one of the four pairs of discharge electrodes 3A, 3B and not opposite to the above-mentioned one of the four pairs of discharge electrodes 3A, 3B is also approximately 90°. In contrast, in each one of the four pairs of discharge electrodes 3A and 3B, an array angle that is formed by the positive discharge electrode 3a and the negative discharge electrode 3b making up the pail is smaller than 90°.

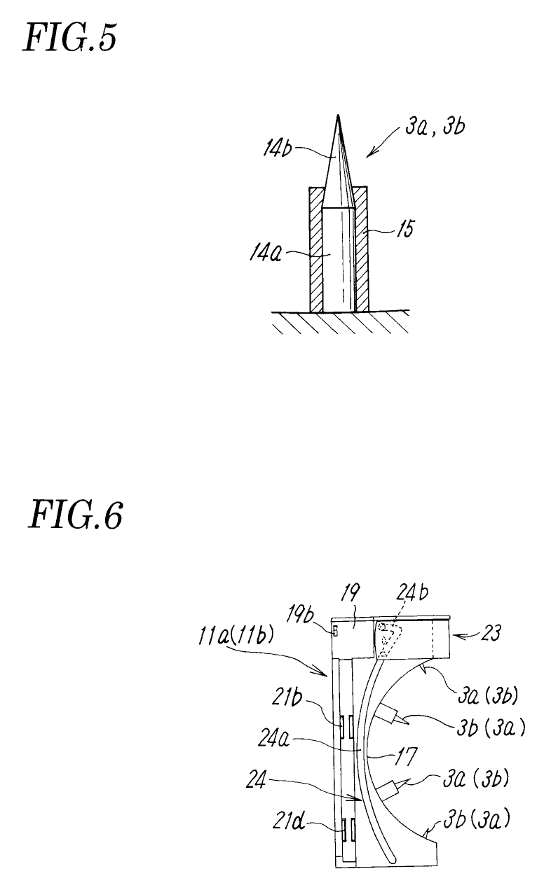

As illustrated in FIG. 5, the discharge electrode 3a, 3b includes a body part 14a that has the shape of a column and a front-end part 14b that has a tapered shape. The front-end part 14b of the discharge electrode 3a, 3b may be hereafter referred to as the tapered part 14b. The columnar body part 14a of the discharge electrode 3a, 3b is either covered/coated by an electric insulation material 15 such as a synthetic resin or the like or embedded in the aforementioned discharge electrode support frame 11a, 11b that is made of a synthetic resin or the like. Therefore, it is only the tapered part 14b of the discharge electrode 3a, 3b that is exposed to the outside. Corona discharge is generated at the exposed tapered part 14b of the discharge electrode 3a, 3b. Positive/negative ions are generated due to the corona discharge. Therefore, the tapered part 14b of the discharge electrode 3a, 3b corresponds to, as a non-limiting example thereof, a “discharging part” according to an aspect of the invention. Accordingly, in the following description of this specification, the reference numeral “14b” may be assigned not only to the tapered part 14b of the discharge electrode 3a, 3b but also to a “discharging part” according to an exemplary embodiment of the invention.

The front-end part 14b of the discharge electrode 3a, 3b may have the shape of, for example, a circular cone, which has a pointed tip as the apex thereof. Or, as another example, the tip of the front-end part 14b of the discharge electrode 3a, 3b may be blunted, which has slight roundness.

An electrical insulator covers the discharge electrode 3a, 3b excluding the discharging part 14b thereof. Because of such an insulation-coated structure in which the discharging part 14b of the discharge electrode 3a, 3b only is exposed, even though the positive discharge electrode 3a and the negative discharge electrode 3b are arrayed in the proximity of each other, a creeping distance from the discharging part 14b of the positive discharge electrode 3a to the discharging part 14b of the adjacent negative discharge electrode 3b via the surface of the electric insulation material 15 and the surface of the discharge electrode support frame 11a, 11b is longer than that of a non-insulation-coated structure in which the discharge electrode 3a, 3b is not covered by an electrical insulator at all. For this reason, the illustrated structure of the discharge electrode 3a, 3b makes it possible to lengthen a serviceable time period that ends at a point in time at which dielectric breakdown occurs due to impurities adhering to the discharge electrode, which is attributable to use for a long time and/or use under severe conditions.

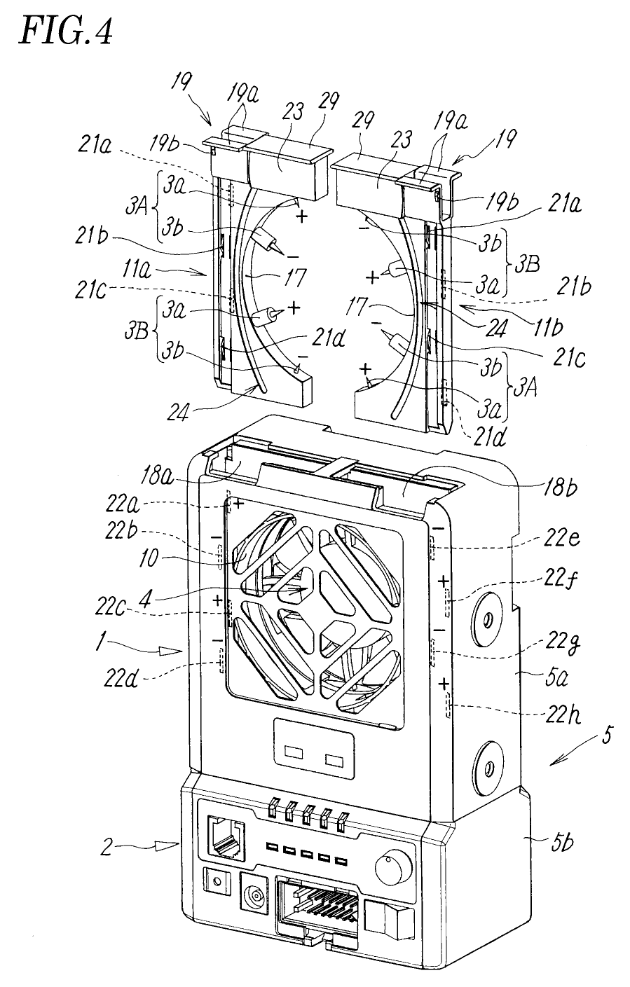

As will be understood from FIG. 4, the positive discharge electrodes 3a and the negative discharge electrodes 3b are mounted on each of the pair of the discharge electrode support frames 11a and 11b. Each of the discharge electrode support frames 11a and 11b has the following shape or has a shape that at least resembles one explained below. A frame member that has a quadrangular shape when viewed in plan is vertically split into two frame segments. Each of the middle part at the split side of these two frame segments, which has been separated from the other, is hollowed in the shape of an arc when viewed in plan. The arc is formed along a part of the inner circumference of the air-blow hole 10. The discharge electrode support frames 11a and 11b have a shape symmetrical to each other. Two pairs of discharge electrodes 3A and 3B are mounted on the curved part 17 of each of the pair of the discharge electrode support frames 11a and 11b. Specifically, one first-type pair of discharge electrodes 3A and one second-type pair of discharge electrodes 3B are mounted on the curved part 17 of each of the pair of the discharge electrode support frames 11a and 11b. The positive discharge electrodes 3a and the negative discharge electrodes 3b are arrayed on the curved part 17 of each of the pair of the discharge electrode support frames 11a and 11b in such a manner that a discharge electrode that has a relatively short electrode length is provided at each edge-side position of the curved part 17 thereof and that other two discharge electrodes each of which has a relatively long electrode length are provided at two center-side positions of the curved part 17 thereof.

Since the distance between the tip of the positive discharge electrode 3a and the center O of the air-blow hole 10 is different from the distance between the tip of the negative discharge electrode 3b and the center O of the air-blow hole 10 in each pair of discharge electrodes 3A and 3B, positive ions and negative ions are generated at positions different from each other when viewed in the direction of the radius of the circular air-blow hole 10. For this reason, it is possible to decrease the incidence of ion recombination due to the mixture of positive ions and negative ions that is otherwise caused by the swirling flow of air supplied from the fain 4. Since the ion recombination rate is reduced, it is possible to increase the amount of ion that reaches a diselectrification target workpiece.

Moreover, since both the first-type pair of discharge electrodes 3A and the second-type pair of discharge electrodes 3B are provided on each of the pair of the discharge electrode support frames 11a and 11b, the distribution of ions in the radial direction of the air-blow hole 10 is made even, which results in an improved ion balance.

The pair of the discharge electrode support frames 11a and 11b is attached to the aforementioned upper case 5a in a detachable manner. Specifically, the pair of the discharge electrode support frames 11a and 11b is inserted in the upper case 5a through a pair of discharge electrode support frame attachment holes 18a and 18b, which is formed through the upper plate of the upper case 5a. The discharge electrode support frames 11a and 11b are inserted through the discharge electrode support frame attachment holes 18a and 18b, respectively, in such an orientation that the curved part 17 of the discharge electrode support flame 11a and the curved part 17 of the discharge electrode support frame 11b face each other. One of the pair of the discharge electrode support frames, the first discharge electrode support frame 11a, is detachably attached at a position corresponding to one half of the air-blow hole 10, whereas the other of the pair of the discharge electrode support frames, the second discharge electrode support frame 11b, is detachably attached at a position corresponding to the other half of the air-blow hole 10.

The first discharge electrode support frame 11a has the same external shape as that of the second discharge electrode support frame 11b. In addition, the first discharge electrode support frame 11a has the same electrode/terminal/member mounting structure as that of the second discharge electrode support flame 11b, including but not limited to, the mounting structure of the discharge electrodes 3a and 3b, the mounting structure of receiving terminals 21a-21d, and the mounting structure of cleaning members 23. A more detailed explanation of the receiving terminals 21a-21d and the cleaning members 23 will be given later. Because of such an identical structure, the first discharge electrode support frame 11a and the second discharge electrode support frame 11b have interchangeability. That is, the first discharge electrode support frame 11a and the second discharge electrode support frame 11b may be interchanged with each other and then can be inserted in the discharge electrode support frame attachment holes 18a and 18b of the upper case 5a in a reversed manner.

A lock member 19 is provided at the upper end of each of the pair of the discharge electrode support frames 11a and 11b. The lock member 19 is made up of a pair of elastic pieces 19a. The elastic pieces 19a of the lock member 19 can be elastically deformed in an opening/closing manner. Each elastic piece 19a of each lock member 19 has a vertical part that extends from the side of the discharge electrode support frame 11a, 11b in an upward direction and a horizontal part that is bent at a substantially right angle from the upper end of the vertical part and extends horizontally outward. A latch projection 19b is formed on the side face of the elastic piece 19a. When the discharge electrode support frame 11a, 11b is inserted in the discharge electrode support frame attachment hole 18a, 18b of the upper case 5a, the latch projection 19b of the elastic piece 19a is brought into engagement with the upper case 5a through the elastic deflection of the elastic piece 19a. As a result, the discharge electrode support frame 11a, 11b is attached to the upper case 5a.

When detaching the discharge electrode support frame 11a, 11b from the upper case 5a, a user elastically deforms the pair of elastic pieces 19a in a direction that the elastic pieces 19a come close to each other so as to disengage the latch projection 19b thereof from the upper case 5a. Then, the user pulls the discharge electrode support frame 11a, 11b out of the discharge electrode support frame attachment hole 18a, 18b of the upper case 5a while making the latch projection 19b of the elastic piece 19a being disengaged from the upper case 5a. In this way, the discharge electrode support frame 11a, 11b can be dismounted from the upper case 5a.

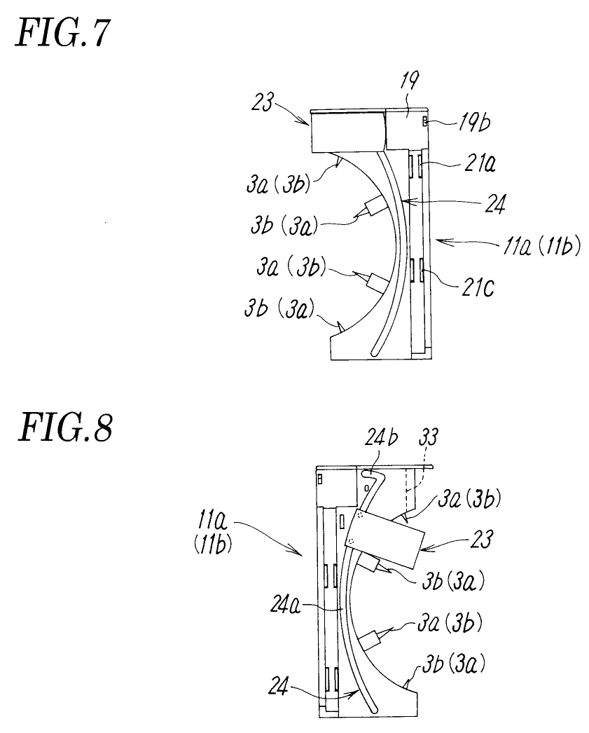

As will be understood from FIGS. 6 and 7, the aforementioned plurality of receiving terminals 21a-21d are formed on the front/rear faces of each of the pair, of the discharge electrode support frames 11a and 11b at positions close to the outer side thereof, which is opposite to the curved-part (17) side. Each of the plurality of receiving terminals 21a-21d provides individual electric connection to the discharge electrode 3a or the discharge electrode 3b. More specifically, the plurality of receiving terminals 21a-21d is provided in the following terminal array layout. Two receiving terminals 21a and 21c are provided on either one of the front/rear faces of each of the pair of the discharge electrode support frames 11a and 11b, where the face of the discharge electrode support frame 11a on which the two receiving terminals 21a and 21c are provided is not the same as the face of the discharge electrode support frame 11b on which the two receiving terminals 21a and 21c are provided. Each receiving terminal 21a is electrically connected to the uppermost discharge electrode 3a, 3b, which has a relatively short electrode length. Each receiving terminal 21c is electrically connected to the third discharge electrode 3a, 3b from the top, which has a relatively long electrode length. Two receiving terminals 21b and 21d are provided on the other of the front/rear faces of each of the pair of the discharge electrode support frames 11a and 11b, where the face of the discharge electrode support frame 11a on which the two receiving terminals 21b and 21d are provided is not the same as the face of the discharge electrode support frame 11b on which the two receiving terminals 21b and 21d are provided. Each receiving terminal 21b is electrically connected to the second discharge electrode 3a, 3b from the top, which has a relatively long electrode length. Each receiving terminal 21d is electrically connected to the lowermost discharge electrode 3a, 3b, which has a relatively short electrode length. These four receiving terminals 21a-21d are arrayed in a vertical direction on the front/rear faces of each of the pair of the discharge electrode support frames 11a and 11b at face-reversed symmetrical positions.

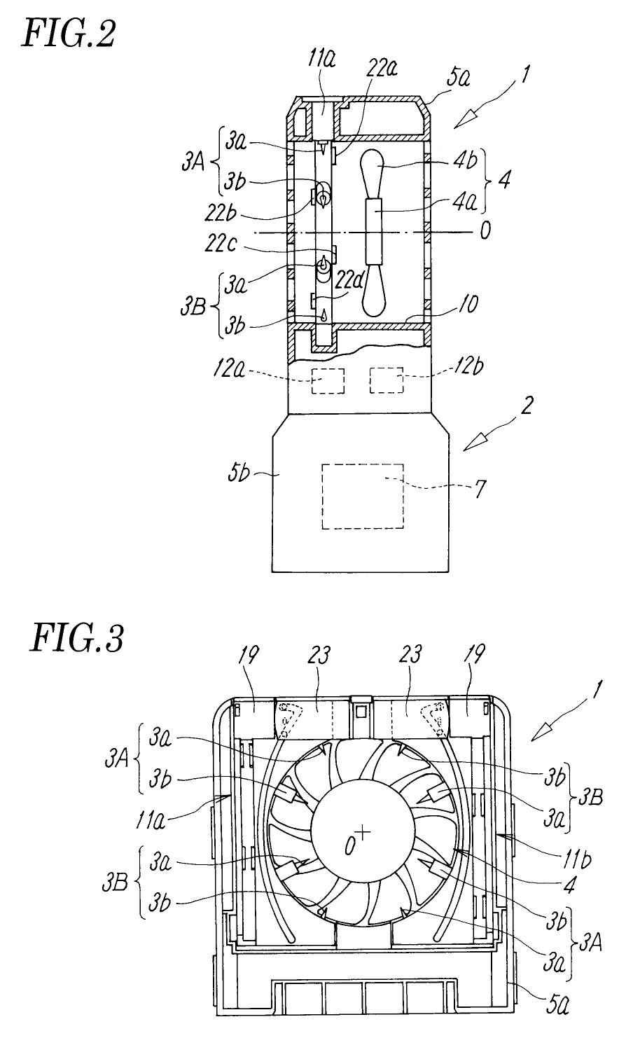

On the other hand, as illustrated in FIGS. 2 and 4, four feeding terminals 22a-22d and four feeding terminals 22e-22h are provided in the discharge electrode support flame attachment holes 18a and 18b of the upper case 5a, respectively. Four positive feeding terminals 22a, 22c, 22f, and 22h are electrically connected to the aforementioned positive high-voltage generating device 12a, whereas four negative feeding terminals 22b, 22d, 22e, and 22g are electrically connected to the aforementioned negative high-voltage generating device 12b. When the pair of the discharge electrode support frames 11a and 11b is inserted in the pair of the discharge electrode support frame attachment holes 18a and 18b of the upper case 5a for attachment, the receiving terminals 21a-21d are brought into contact with the feeding terminals 22a-22h, which establishes electric connection therebetween. As a result, a high voltage of a corresponding polarity is applied to each discharge electrode 3a, 3b.

In the illustrated example of the configuration of an ionizer according to the present embodiment of the invention, the two positive feeding terminals 22a and 22c, each of which is electrically connected to the positive high-voltage generating device 12a, are provided on the rear inner wall surface of the first discharge electrode support frame attachment hole 18a at two vertically different positions with the positive feeding terminal 22a being the upper terminal thereof. In addition, the two negative feeding terminals 22b and 22d, each of which is electrically connected to the negative high-voltage generating device 12b, are provided on the front inner wall surface of the first discharge electrode support frame attachment hole 18a at two vertically different positions with the negative feeding terminal 22b being the upper terminal thereof. The two positive feeding terminals 22f and 22h, each of which is electrically connected to the positive high-voltage generating device 12a, are provided on the rear inner wall surface of the second discharge electrode support frame attachment hole 18b at two vertically different positions with the positive feeding terminal 22f being the upper terminal thereof. In addition, the two negative feeding terminals 22e and 22g, each of which is electrically connected to the negative high-voltage generating device 12b, are provided on the front inner wall surface of the second discharge electrode support frame attachment hole 18b at two vertically different positions with the negative feeding terminal 22e being the upper terminal thereof.

Since an ionizer according to the present embodiment of the invention has the terminal arrangement explained above, when the first discharge electrode support frame 11a is inserted in the first discharge electrode support frame attachment hole 18a for attachment, the two receiving terminals 21a and 21c of the first discharge electrode support frame 11a become electrically connected to the two positive feeding terminals 22a and 22c of the first discharge electrode support frame attachment hole 18a, respectively; in addition, the two receiving terminals 21b and 21d of the first discharge electrode support frame 11a become electrically connected to the two negative feeding terminals 22b and 22d of the first discharge electrode support frame attachment hole 18a, respectively. On the other hand, when the second discharge electrode support frame 11b is inserted in the second discharge electrode support frame attachment hole 18b for attachment, the two receiving terminals 21a and 21c of the second discharge electrode support frame 11b become electrically connected to the two negative feeding terminals 22e and 22g of the second discharge electrode support frame attachment hole 18h, respectively; in addition, the two receiving terminals 21b and 21d of the second discharge electrode support frame 11b become electrically connected to the two positive feeding terminals 22f and 22h of the second discharge electrode support frame attachment hole 18b, respectively. Therefore, the polarity of a high voltage that is applied to each of the discharge electrodes 3a and 3b of the discharge electrode support frames 11a and 11b is as illustrated in FIG. 4.

The polarity of each of the discharge electrodes 3a and 3b of the discharge electrode support frames 11a and 11b becomes reversed if the first discharge electrode support frame 11a and the second discharge electrode support frame 11b are replaced with each other while reversing each of the face orientation of the first discharge electrode support frame 11a and the second discharge electrode support frame 11b so that the front face thereof becomes the rear face thereof. That is, if the first discharge electrode support frame 11a is inserted in the second discharge electrode support frame attachment hole 18b after the interchanging and reversing explained above, which means that the second discharge electrode support frame 11b is inserted in the first discharge electrode support frame attachment hole 18a, the polarity of each of the discharge electrodes 3a and 3b of the discharge electrode support frames 11a and 11b becomes reversed. When interchanged and reversed as explained above, the reference signs 11a and 11b are reversed in FIG. 4.

Generally speaking it is known in the art that the degree of wear and tear of a positive discharge electrode is not the same as that of a negative electrode when corona discharge is generated at the discharge electrodes. In view of the above, as has already been explained earlier, the first discharge electrode support frame 11a and the second discharge electrode support frame 11b according to the present embodiment of the invention have interchangeability, which allows the first discharge electrode support frame 11a and the second discharge electrode support frame 11b to be replaced with each other periodically so that the polarity of the discharge electrodes 3a and 3b is switched over between positive and negative. The periodic polarity reversal makes it possible to equalize the degree of wear and tear between the discharge electrodes 3a and 3b. For this reason, it is possible to extend the total serviceable time period thereof.

The aforementioned cleaning member 23, which is used for cleaning the discharge electrodes 3a and 3b, is moveably attached to each of the pair of the discharge electrode support frames 11a and 11b. Each of the discharge electrode support frames 11a and 11b has a guide 24. The cleaning member 23 is attached to each discharge electrode support frame 11a, 11b in such a manner that it can be slid along the guide 24.

The cleaning member 23 includes a brush holder 25, a brush 26, and a slider 27. As will be understood from FIGS. 4, 9, and 10, the cleaning member 23 has the following structure. The brush holder 25 has a grooved body in a sectional view. The brush holder 25 is moveably attached to the discharge electrode support frame 11a, 11b at the aforementioned curved-part (17) side thereof. The grooved brush holder 25 sandwiches a part of the discharge electrode support frame 11a, 11b at each movement position. The brush 26 is provided inside the grooved brush holder 25 in such a manner that it can be brought into contact with the discharge electrode 3a, 3b. The slider 27 is provided at the base end of the brush holder 25. The slider 27 is in engagement with the guide 24. Since the slider 27 can move along the guide 24, the cleaning member 23 can be slid thereon.

The brush holder 25 is made of an electric insulation material such as a synthetic resin or the like. The brush holder 25 includes a left side plate part 25a, a right side plate part 25a, and a connection end plate part 25b. The end plate part 25b is formed as the bottom part of the groove at the front end, that is, the end opposite to the base end, of each of the left/right side plate parts 25a. The brush 26 is provided on the inner surface of the end plate part 25b of the brush holder 25. The brushing end of the brush 26 is directed toward the base end of the brush holder 25. At the time when the cleaning member 23 passes through the mount position of the discharge electrode 3a, 3b, the brush 26 is brought into contact with the front-end part 14b of the discharge electrode 3a, 3b, that is, the discharging part 14b thereof. As a result, the brush 26 sweeps dust or other particles off the discharging part 14b thereof. The brush 26 is fixed to a brush base 26a. The brush base 26a is attached to the inner surface of the end plate part 25b of the brush holder 25. The brush base 26a may be provided as a detachable member.

The guide 24 is provided as an arc groove that is formed adjacent to the curved part 17 in each of the front surface and the rear surface of each of the pair of the discharge electrode support frames 11a and 11b. The guide 24 includes a main guiding rail part 24a and a recess part 24b. The main guiding rail part 24a of the guide 24 extends roughly along the curved part 17. The recess part 24b, which does not constitute a part of the arc, extends from one end, specifically, the upper end, of the main guiding rail part 24a. The recess part 24b extends away from the curved part 17. Since the recess part 24b extends from the upper end of the main guiding rail part 24a in a direction that is roughly opposite to a direction toward the curved part 17 whereas the main guiding rail part 24a extends roughly along the curved part 17 so as to form the arc, the guide 24 is bent it an acute angle at the point of a juncture therebetween, that is, at the upper end mentioned above.

The radius of curvature of the main guiding rail part 24a of the guide 24 is larger than that of the curved part 17 of the discharge electrode support frame 11a, 11b. In addition, the center of curvature of the main guiding rail part 24a lies at a position different from the center of curvature of the curved part 17, or more specifically, at a position on the extension of the radius of curvature of the curved part 17. Therefore, the distance between the main guiding rail part 24a and the curved part 17 is the shortest substantially at the center of the curved part 17. The distance between the main guiding rail part 24a and the curved part 17 increases toward each edge of the curved part 17. For this reason, when measured along the length of the brush holder 25, the distance from the main guiding rail part 24a of the guide 24 to the discharging part 14b of the shorter electrode-length discharge electrode 3a, 3b, which is provided at each edge-side position of the curved part 17, is substantially equal to the distance from the main guiding rail part 24a of the guide 24 to the discharging part 14b of the longer electrode-length discharge electrode 3a, 3b, which is provided at each center-side position of the curved part 17. Thus, it is possible to clean, by means of the brush 26 of the cleaning member 23 with reliable cleaning performance, the discharging part 14b of each of the discharge electrodes 3a and 3b although some of them have a relatively short electrode length and the others have a relatively long electrode length.

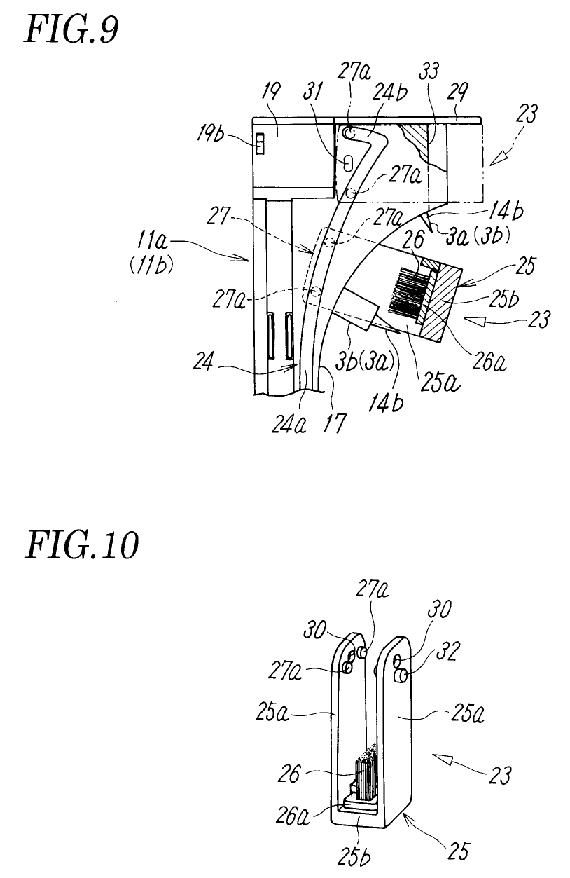

The slider 27 is made up of a plurality of sliding projections 27a that is formed on the inner surface of the left/right side plate parts 25a of the brush holder 25. Two sliding projections 27a are formed on the inner surface of each side plate part 25a of the brush holder 25. These two sliding projections 27a are fitted in a groove that constitutes the guide 24 in each surface. At the time when the discharge electrodes 3a and 3b are cleaned with the use of the cleaning member 23, as illustrated in FIGS. 8 and 9, the sliding projections 27a of the cleaning member 23 ale slid along the main guiding rail part 24a of the guide 24 while being in engagement with the main guiding rail part 24a. At the time when the cleaning member 23 is not used for cleaning the discharge electrodes 3a and 3b, as indicated with a chain double-dashed line in FIG. 9, the upper one of the two sliding projections 27a of the cleaning member 23 is fitted into the retraction end of the recess part 24b so that the cleaning member 23 is moved to and held at its non-cleaning retraction position.

When the cleaning member 23 has been retracted to its non-cleaning position, it is oriented in a direction parallel to the top of the discharge electrode support frame 11a, 11b. In addition, when the cleaning member 23 is set at the non-cleaning retraction position, it is in contact with the lower surface of an eave frame 29 that is fixed to the upper end of the discharge electrode support frame 11a, 11b. Each of the pair of the discharge electrode support frames 11a and 11b is attached to the upper case 5a with the cleaning member 23 being set at the non-cleaning retraction position. When the cleaning member 23 is set at the non-cleaning retraction position, it is distanced from the flowing path of air that is supplied from the fan 4 in the air-blow hole 10. Therefore, in no case is ail that flows in the air-blow hole 10 shut off or disturbed by the cleaning member 23.

A latch hole 30 is formed through each of the left/right side plate parts 25a of the brush holder 25. On the other hand, a latch projection 31 is formed on each of the pair of the discharge electrode support frames 11a and 11b. When the cleaning member 23 is set at the non-cleaning retraction position, the latch projection 31 fits in the latch hole 30 so that the cleaning member 23 is held thereat.

In addition, al lock projection 32 is formed on the outer surface of each of the left/right side plate parts 25a. When the discharge electrode support frame 11a, 11b is attached to the upper case 5a, the lock projection 32 is brought into locking engagement with a part of the upper case 5a, which prevents the cleaning member 23 from moving to a cleaning position when it is not supposed to.

The reference numeral 33 shown in FIG. 9 denotes a concavity that is formed in the curved-part (17) end face of the discharge electrode support frame 11a, 11b. When the cleaning member 23 is set at the non-cleaning retraction position, the brushing-end part of the brush 26 fits in the concavity 33.

When the cleaning of the discharge electrodes 3a and 3b of an ionizer according to the present embodiment of the invention, which has the configuration explained above, is conducted, as a first step, the operation of the ionizer is stopped. Then, the pair of the discharge electrode support frames 11a and 11b is detached from the upper case 5a as illustrated in FIG. 4. Next, as illustrated in FIGS. 8 and 9, the cleaning member 23 that is set at the non-cleaning retraction position is moved to an on-the-arc position so that the cleaning member 23 can be slid along the guide 24. Then, the cleaning member 23 is moved along the main guiding rail part 24a of the guide 24 in reciprocatory motion. The cleaning member 23 may be slid back and forth along the main guiding rail part 24a of the guide 24 just once. Or, the cleaning member 23 may be reciprocated along the main guiding rail part 24a of the guide 24 twice or more. During the reciprocatory sliding of the cleaning member 23, it moves from one discharge electrode 3a, 3b to another as well as between one discharge electrode 3a, 3b and another while changing its position and orientation gradually with the body thereof projecting in the airflow area of the air-blow hole 10 when viewed from the curved part 17. When the cleaning member 23 is slid through the discharge electrodes 3a and 3b one after another, the brush 26 of the cleaning member 23 is brought into contact with the discharging parts 14b of the discharge electrodes 3a and 3b in a sequential manner. As a result, the brush 26 sweeps dust or other particles off the discharging parts 14b thereof one after another.

If the cleaning of the unclean discharge electrodes 3a and 3b of the ionizer is conducted after, as a first step, the operation of the ionizer has been stopped, and then, the pair of the discharge electrode support frames 11a and 11b has been detached from the upper case 5a as explained above, it is possible to prevent any dust or other particles swept off the discharging parts 14b of the discharge electrodes 3a and 3b from being scattered by the flow of air. In the operation of an ionizer of related art, scattered dust or other particles could re-adhere to other part of the ionizer. Or, the scattered dust or other particles could flow out of the ionizer and contaminate a diselectrification environment. Or, the scattered dust or other particles could be blown to a diselectrification target workpiece and make it unclean. These problems of related art can be overcome by cleaning the discharge electrodes 3a and 3b of the ionizer after the stopping of the operation of the ionizer and the removal of the pair of the discharge electrode support frames 11a and 11b from the upper case 5a.

When the cleaning of the discharge electrodes 3a and 3b has been completed, a user moves the cleaning member 23 back to the upper end of the guide 24 so as to fit the upper one of the two sliding projections 27a thereof into the retraction end of the recess part 24b. In such a positional state, the cleaning member 23 occupies the non-cleaning retraction position that is distanced from the airflow area of the air-blow hole 10. The operation of the ionizer becomes possible by attaching the pair of the discharge electrode support frames 11a and 11b to the upper case 5a with the cleaning member 23 being set at the non-cleaning retraction position. When the ionizer is operated, since the cleaning member 23 is set at the non-cleaning retraction position that is distanced from the airflow area of the air-blow hole 10, in no case is the flow of air that is supplied by the fin 4 shut off or disturbed by the cleaning member 23. For this reason, an ionizer according to the present embodiment of the invention makes it possible to overcome the disadvantages of an ionizer of related art in a reliable manner, including but not limited to, decreased air-blowing efficiency, or the occurrence of ion recombination due to the mixture of positive ions and negative ions that is caused by the swirling flow of air, which results in a decrease in the amount of ion that reaches a diselectrification target workpiece.

The aforementioned eave frame 29 that is fixed to the upper end of the discharge electrode support frame 11a, 11b functions as a position determination member that determines the non-cleaning retraction position of the cleaning member 23. In addition to the position determination function, the eave frame 29 has another function of covering the open upper end of the discharge electrode support frame attachment hole 18a, 18b when the discharge electrode support frame 11a, 11b is inserted in the discharge electrode support frame attachment hole 18a, 18b of the upper case 5a for attachment.

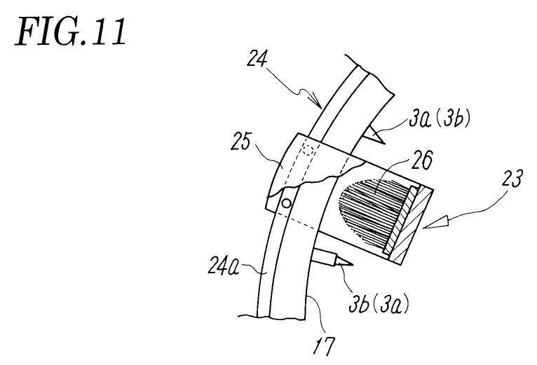

In the foregoing description of an example of the configuration of an ionizer according to in exemplary embodiment of the invention, the brush 26 of the cleaning member 23 is made of fibers having a certain uniform length so that the brushing end of the brush 26 forms a single flat plane. Notwithstanding the foregoing, however, the brushing end of the brush 26 may be formed as, for example, a rounded convex as illustrated in FIG. 11. If the brushing end of the brush 26 forms such a curved face, the rounded brushing face of the brush 26 can be brought into contact with various parts of the discharge electrodes 3a and 3b. Therefore, the cleaning capability of the brush 26 is improved. In addition, if the electrode length of the positive discharge electrode 3a is not so different from that of the negative discharge electrode 3b, the rounded convex configuration of the brush 26 explained above makes it possible to form the main guiding rail part 24a of the guide 24 as an arc that is concentric with the arc of the curved part 17 of the discharge electrode support frame 11a, 11b.

In the illustrated configuration of an ionizer according to an exemplary embodiment of the invention, two pairs of discharge electrodes 3A and 3B, that is, one first-type pair of discharge electrodes 3A and one second-type pair of discharge electrodes 3B, are mounted on the curved part 17 of each of the pair of the discharge electrode support frames 11a and 11b. However, the scope of this aspect of the invention is not limited to such an exemplary configuration. For example, only one pair of discharge electrodes 3A, 3B may be mounted on the curved part 17 of the discharge electrode support frame 11a, 11b. Or, as another modification example, three pairs or more of discharge electrodes 3A, 3B may be mounted on the curved part 17 of the discharge electrode support frame 11a, 11b.

In the foregoing description of an exemplary embodiment of the invention, an ionizer is provided with the pair of the discharge electrode support frames 11a and 11b that is separated from each other. Notwithstanding the foregoing, however, as a modification example thereof, the discharge electrode support frames 11a and 11b may be formed into a single discharge electrode support frame. That is, an ionizer may be provided with only one non-split discharge electrode support frame. In such a modified configuration, the ionizer may be provided with a pair of cleaning members 23 one of which is used for the cleaning of discharge electrodes mounted on one half of the single discharge electrode support flame and the other of which is used for the cleaning of discharge electrodes mounted on the other half of the single discharge electrode support frame. Or, the ionizer may be provided with only one cleaning member 23 that is configured to be capable of moving along the entire circumference of the air-blow hole 10.

It is not always necessary that the electrode length of the positive discharge electrode 3a should be different from the electrode length of the negative discharge electrode 3b in each pair of discharge electrodes 3A, 3B. In other words, it is not always necessary that the between-tip-and-center distance of the positive discharge electrode 3a defined earlier should be different from the between-tip-and-center distance of the negative discharge electrode 3b defined earlier in each pair of discharge electrodes 3A, 3B. If it is not so necessary to take measures against the problem of ion recombination due to the mixture of positive ions and negative ions, the electrode length of the positive discharge electrode 3a may be the same as the electrode length of the negative discharge electrode 3b in each pair of discharge electrodes 3A, 3B. In such a modified configuration, the main guiding rail part 24a of the guide 24 is formed as an arc that is concentric with the arc of the curved part 17.

An ionizer according to the foregoing exemplary embodiment of the invention is explained as a DC device. Notwithstanding the foregoing, however, the invention may be applied to an AC ionizer. When the invention is applied to an AC ionizer, an AC high voltage is applied to two discharge electrode 3a and 3b that make up each pair of discharge electrodes 3A, 3B at such timing that the polarity of the discharge electrode 3a and the polarity of the discharge electrode 3b are opposite to each other.

What is claimed is:

1. An ionizer having a discharge-electrode cleaning mechanism, the ionizer comprising:
a case;
an air hole formed in the case;
a fan that supplies air, the fan being provided inside the air hole;
a plurality of discharge electrodes that generates positive ions and negative ions by corona discharge, the plurality of discharge electrodes being provided at positions exposed to and/or facing the air hole in the case;
an electrode support frame that is detachably attached to the case with the plurality of discharge electrodes being mounted on the electrode support frame; and
a cleaner for cleaning the plurality of discharge electrodes, the cleaner moveably attached to the electrode support frame in such a manner that the cleaner can move from one discharge electrode to another as well as between one discharge electrode and another while being brought into contact with the plurality of discharge electrodes one after another,
wherein the cleaner occupies a retraction position that is distanced from the area of the air hole when the electrode support frame is attached to the case; and
the cleaner becomes moveable for the purpose of cleaning the plurality of discharge electrodes when the electrode support frame is detached from the case.

2. The ionizer according to claim 1,
wherein the electrode support frame is made up of a first electrode support frame that is detachably attached at a position corresponding to one half of the air hole and a second electrode support frame that is detachably attached at a position corresponding to the other half of the air hole; and
the plurality of discharge electrodes and the cleaner are provided on each of the first electrode support frame and the second electrode support frame.

3. The ionizer according to claim 2,
wherein each of the first electrode support frame and the second electrode support frame includes
a curved part that has the shape of an arc that coincides with a part of the air hole that has the shape of a circle, and
a guide that is formed adjacent to the curved part in each of the front face and the rear face of each of the electrode support frames,
wherein each discharge electrode is mounted on the curved part of each of the electrode support frames in such a position and orientation that a discharging part of each discharge electrode protrudes in the air hole;
wherein the cleaner, which is configured to move freely along the guide of each of the electrode support frames, includes
a brush holder that is attached at the curved part of each of the electrode support frames in such a manner that the brush holder sandwiches a part of each of the electrode support frames;
a brush that is provided inside the brush holder in such a manner that the brush can be brought into contact with the discharge electrode; and
a slider that can slide freely along the guide.

4. The ionizer according to claim 3,
wherein the guide, which is formed as a groove, includes
a main part that is gently curved along the curved part; and
a recess part that extends from one end of the main part in such a manner that the guide is bent at the one end of the main part;
wherein the slider is made up of a plurality of sliding projections that fits in the guide so as to be able to slide freely along the guide, the plurality of sliding projections being formed on the inner surface of side plate parts of the brush holder; and
when the cleaner is moved to the end of the guide in such a manner that some of the sliding projections is/are fitted in the recess part, the cleaner occupies the retraction position.

5. The ionizer according to claim 2,
wherein the first electrode support frame and the second electrode support flame have interchangeability so that the electrode support frame can be used even when the first electrode support frame and the second electrode support frame are replaced with each other.

6. The ionizer according to claim 3,
wherein the first electrode support frame and the second electrode support frame have interchangeability so that the electrode support frame can be used even when the first electrode support frame and the second electrode support frame are replaced with each other.

7. The ionizer according to claim 1,
wherein the case is provided with a plurality of feeding terminals that is electrically connected to a high voltage source;
the electrode support frame is provided with a plurality of receiving terminals that is electrically connected to the discharge electrodes; and
the receiving terminals become connected to the feeding terminals upon the attachment of the electrode support frame to the case.

8. The ionizer according to claim 2,
wherein the case is provided with a plurality of feeding terminals that is electrically connected to a high voltage source;
the electrode support frame is provided with a plurality of receiving terminals that is electrically connected to the discharge electrodes; and
the receiving terminals become connected to the feeding terminals upon the attachment of the electrode support frame to the case.

9. The ionizer according to claim 1, comprising a plurality of pairs of discharge electrodes each of which is made up of a pair of discharge electrode that generate ion having polarities opposite to each other,
wherein a distance from the tip of one of the two discharge electrodes in each pair of discharge electrodes to the center of the air hole is different from a distance from the tip of the other of the two discharge electrodes in each pair of discharge electrodes to the center of the air hole.

10. The ionizer according to claim 2, comprising a plurality of pairs of discharge electrodes each of which is made up of a pair of discharge electrodes that generate ion having polarities opposite to each other,
wherein a distance from the tip of one of the two discharge electrodes in each pair of discharge electrodes to the center of the air hole is different from a distance from the tip of the other of the two discharge electrodes in each pair of discharge electrodes to the center of the air hole.
